(19) United States
(12) Patent Application Publication
(10) Pub. No.: US 2007/0201631 A1
(43) Pub. Date: Aug. 30, 2007

(54) System and method for defining, synthesizing and retrieving variable field utterances from a file server

(75) Inventors: Ellis K. Cave, Plano, TX (US); Michael J. Polcyn, Allen, TX (US)

Correspondence Address: FULBRIGHT & JAWORSKI L.L.P, 2200 ROSS AVENUE, SUITE 2800, DALLAS, TX, 75201-2784, US

(73) Assignee: Intervoice Limited Partnership, Dallas, TX (US)

(21) Appl. No.: 11/361,846

(22) Filed: Feb. 24, 2006

(51) Int. Cl. H04M 1/64

(52) U.S. Cl. 379/88.01

(57) ABSTRACT

There is disclosed a system and method for addressing an audio file server to play pre-recorded audio files, including variable audio files, using a query URL containing the required file's attributes, without requiring a fully-resolved file address. The HTTP URL protocol is used by adding attributes, such as the language, the speaker, and a text version of the desired message, along with other required attributes of the audio file to the URL. The audio file server accepts and analyzes the attributes in the URL to find out what type of variable field is being requested. Normally, variable field prompts created from spliced audio clips are restricted to a few specific types of variable fields, such as time, date, or amount, fields, or numeric strings such as telephone numbers, credit card numbers, etc. Once the audio file server determines the field type, language and speaker from the URL, it examines the field text value from the query attribute string. The file server then calculates and retrieves the set of utterances required to create the desired phrase. The audio file server splices all of the short files together, and returns the completed utterance to the voice browser for playing to the user.

### CONCURRENTLY FILED APPLICATIONS

The present application is related to copending and commonly assigned U.S. patent application Ser. No. ______ [Attorney Docket No. 47524-P137US-10501428] entitled “SYSTEM AND METHOD FOR MANAGING FILES ON A FILE SERVER USING EMBEDDED METADATA AND A SEARCH ENGINE,” U.S. patent application Ser. No. [Attorney Docket No. 47524-P138US-10501429] entitled “SYSTEM AND METHOD FOR RETRIEVING FILES FROM A FILE SERVER USING FILE ATTRIBUTES,” and U.S. patent application Ser. No. ______ [Attorney Docket No. 47524-P139US-10503962] entitled “SYSTEMS AND METHODS FOR DEFINING AND INSERTING METADATA ATTRIBUTES IN FILES,” filed concurrently herewith, the disclosures of which are hereby incorporated herein by reference.

### TECHNICAL FIELD

This invention relates to interactive voice response (IVR) systems in general and more particularly to such systems in which variable voice audio files are retrieved from an audio file server by using attributes associated with the audio file request.

### BACKGROUND OF THE INVENTION

The existing voice XML (VXML) standard makes the assumption that there are only two ways audio messages in a system, audio generated at runtime from a text-to-speech (TTS) engine, and pre-recorded audio files. These two types of files are referenced in different ways. To reference a TTS engine and cause it to generate a specific speech utterance one must use a <prompt> tag in which the desired message (in text format) follows the <prompt> tag. When the browser encounters the text following a <prompt> tag the browser will send the text to a TTS engine. The TTS engine then renders the text into an audio (.wav) file to be played to a destination. This rendering is from “scratch” in that the TTS engine creates the audio file following a set of creation rules.

The second method of rendering a voice message using VXML is to use an <audio> tag instead of the <prompt> tag. The <audio> tag has associated with it a fully resolved address pointing to the storage location where the desired audio file resides. The browser then directs the request to the desired address and the desired audio file is retrieved from the specified address.

Several problems exist with TTS devices, including low audio quality, high processing overhead, and high cost. TTS technology vendors typically charge a per-port license fee, and their licenses usually require one TTS channel per port on the voice browser, keeping costs high. The reduced audio quality comes about because each word must be generated electronically based on a set of rules. Thus, even the best of these systems have somewhat of an unnatural sound. However, there are many applications where TTS may appear to be the only way to communicate the correct information to the user. Many IVR applications require information to be spoken to a user, where the information is not known at the time that the pre-recorded audio files are recorded. Variable information, such as bank balances, flight information, dates, email contents, etc. cannot be pre-recorded at application design time, since the spoken times, dates, amounts, email contents are not known at that time. TTS technology has been the common way for these types of variable information to be spoken to a user in an IVR script.

Before the advent of commercially viable TTS, IVR vendors utilized an alternate method to create variable field utterances. The method was called “catenated fields”. By splicing or catenating short pre-recorded utterances together, one can build an utterance, such as “Your account balance is three hundred, twenty-five dollars and fourteen cents”. This utterance would be generated by splicing eight short utterances together. The utterances would be:
1) Your account balance is
2) three
3) hundred
4) twenty
5) five
6) dollars and
7) fourteen
8) cents

This splicing technique can produce utterances that are very natural-sounding, yet not too difficult to generate. The application designer would have to pre-record a set of digits: 0-9; tens, 10-90; hundreds, 100-900; and other short phrases such as “your account balance is”, “dollars and”, “cents”. But the result is quite natural sounding, particularly if one uses several inflection alternatives for different portions of the utterance (see, for example, U.S. patent application Ser. No. 10/964,046 by Forrest McKay, entitled “SYSTEM AND METHOD FOR AUTOMATED VOICE INFLECTION FOR NUMBERS,” which is hereby incorporated herein by reference.

Early IVR vendors discovered that they could cause the system to speak most times, dates, currency amounts, and other variable fields in a natural-sounding way, by pre-recording a few hundred audio phrases.

Standard voice scripting languages, such as VXML or SALT, typically assume that one will use TTS for any variable-field utterances. Pre-recorded audio files are reserved for standard introductions, i.e.: “Would you like your account balance, or your cleared checks?” Attempts to use concatenated or other alternate technologies, instead of TTS devices have been restricted since the standard VXML and SALT audio-play command tags (<prompt>, <audio>, etc.) do not efficiently deal with concatenated messages such as monetary amounts, times, dates, phone numbers, etc. that may be different each time that the field value is spoken. These types of audio messages are called “variable-field” messages. The audio-play commands in VXML and SALT assume that a message is either pre-recorded (use of the <audio> tag) or that it must be entirely generated from scratch by a TTS engine (<prompt> tag). To play catenated messages, the list of message would have to be dynamically generated at run-time, and each single audio clip would have to be requested individually from the audio file storage device.

In situations where variable fields are required, the choice is either to use a TTS rendering for each value in the variable field or to concatenate prerecorded values in a proper order. The VXML or SALT protocol does not support concatenation, unless the application programmer wants to manually define a string of short audio clips to be played sequentially. There are a number of variable-field utterances that appear quite often in voice scripts, i.e., currency amounts, dates, times, credit card numbers, phone numbers, etc.). It is desired to use the VXML protocol to define the generation and retrieval of such messages using catenated utterances, because of the lower cost and more natural sound. However, it is not obvious how these catenated utterances could be efficiently described using standard VXML or SALT commands. Currently available techniques would require the application developer to generate a long list of audio file URLs in the VXML code to cause the message “Your account balance is $324.56.” This patent describes a method to make this process much more efficient.

J Currently, one can manually cause a VXML browser to generate a catenated variable field utterance by scripting a series of “play” audio commands in the VXML or SALT scripting language. For example, to retrieve the account balance of $324.14 a string of commands such as play audio, “Your account balance is”; play audio, “300”; play audio “20”; play audio “4”; play audio “dollars”; play audio “and”; play audio “fourteen”; play audio, “cents”. This is inefficient because the browser must then fetch each one of those audio files from the audio file server (or from wherever it is) and bring it over as a separate fetch. This results in a round trip for the fetch of each utterance fragment all of which then must be spliced together with the other fetched utterances in the browser. Note that the browser is doing the fetching of each individual audio clip, and the browser splices the fetched audio clips together. Once all the parts are fetched, then the message “Your account balance is $324.14” can be played to the user. This is very inefficient. Thus, most systems use the TTS engine to accommodate these variable numeric, currency, or date fields.

### BRIEF SUMMARY OF THE INVENTION

In one embodiment, there is disclosed a system and method for addressing an audio file server to play pre-recorded variable-field audio files using a URL where the information required for the variable field is included in the URL to the audio file server. The files required to build the complete utterance are not addressed individually, and the URL does not require a fully-resolved message address. The audio file server has specialized functions that allow the server to accept specially-defined URLs, calculate the required files to be spliced together to create a complete utterance and then generate the appropriate final audio file by catenating all the correct audio file clips together into a single file. In one embodiment, the HTTP protocol is used to define the contents of the variable-field utterance by adding query attributes such a text version of the desired message, along with other required attributes of the audio file, such as the type of utterance (monetary amount, date, numeric, etc.) recorded by John, spoken in a happy voice, spoken in English, etc. The basic technique of passing key/value pair attributes is described in detail in U.S. patent application Ser. No. ______ [Attorney Docket No. 47524-P138US-10501429] entitled “SYSTEM AND METHOD FOR RETRIEVING FILES FROM A FILE SERVER USING FILE ATTRIBUTES,” which is hereby incorporated herein by reference. Note that there are two critical attributes that are required to generate most of the spliced variable-field messages. These are the text of the variable field and the field type. The field text is simply the text of the field to be spoken ($203.79, Dec. 17, 2005, 214-457-8945, etc.). The field type describes how the field text is to be interpreted: as a currency amount, a date, a time, a credit card number, a phone number, etc. For example, the field text 10.05 could be interpreted as a date (October 2005) or an amount $10.05). These attributes are placed after a “?” in the URL address string. The HTTP query protocol is such that all of the attributes which follow the “?” will be passed to the audio file server for resolution by the audio file server. The audio file server parses out the attributes and analyzes the attributes to find out what type of variable field is being requested. Normally, catenated audio messages will be restricted to a few specific types of common variable fields, such as time, date, or monetary amount, fields, or numeric strings such as telephone numbers, credit card numbers, etc. This limits the number of pre-recorded audio clips that must be recorded. Once the audio file server determines the field type, it examines the field value from the query attribute string and retrieves the set of utterances required to create the desired phrase. The system can also store the same audio clip (for example the digit utterance “one”) in several different inflections. The system can then calculate the appropriate inflections for each individual audio clip that goes into the final utterance. By selecting the correct inflections for each section of the utterance, the final spliced utterance will sound more natural than if neutrally-inflected clips were used for all of the splices. The audio file server splices all of the short files together, and returns the completed utterance to the voice browser for playing to the user. Also see U.S. patent application Ser. No. 10/964,046 by Forrest McKay, entitled “SYSTEM AND METHOD FOR AUTOMATED VOICE INFLECTION FOR NUMBERS,” which was referenced earlier for a more detailed description of the inflection process, and which is incorporated herein by reference.

In one embodiment, the description of a variable message is contained in the data that is passed to the audio file server such that the audio file server, using a concatenation engine, can combine audio clips to create a variable field utterance according to attributes associated with the data.

Embodiments of the invention how an external entity can specify and retrieve variable field audio files, using a query URL to describe the variable contents and other attributes of the file. A user will specify a variable field utterance such as a monetary amount ($325.49) by an attribute URL. The attribute URL will define the type of field (monetary, date phone number, etc.) as well as the text of the field ($325.49). Other attributes, such as the speaker and language can also be specified in the attribute URL. The server will parse the URL and extract the type and text attributes. An internal process, e.g. the ISAY process, calculates the set of audio clips that will have to be spliced together to generate the phrase “$325.49” then synthesizes the variable field utterance by splicing many short utterances into the fully-formed phrase “Three hundred twenty-five dollars and forty-nine cents”. The server returns the completed, concatenated single file to the requestor. For further information on query URLs please see U.S. patent application Ser. No. ______, [Attorney Docket Number [47524-P139US-10501429] entitled “SYSTEM AND METHOD FOR RETRIEVING FILES FROM A FILE SERVER USING FILE ATTRIBUTES,” which is hereby incorporated herein by reference. Also see U.S. patent application Ser. No. 10/964,046 by Forrest McKay, entitled “SYSTEM AND METHOD FOR AUTOMATED VOICE INFLECTION FOR NUMBERS,” which was referenced earlier for a more detailed description of the inflection process.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the present invention, reference is now made to the following descriptions taken in conjunction with the accompanying drawings, in which:

FIGS. 1A, 1B, 1C and 1D show the prior art system for using <audio> tags for retrieving messages;

FIGS. 2A and 2B show one embodiment of a system that will cause the enhanced file server in the system to splice together all of the appropriate audio clips to produce two different variable-field utterances; and

FIGS. 3 and 4 show embodiments of a process for passing metadata pertaining to an audio file into the audio file server and for creating the desired concatenated audio file.

### DETAILED DESCRIPTION OF THE INVENTION

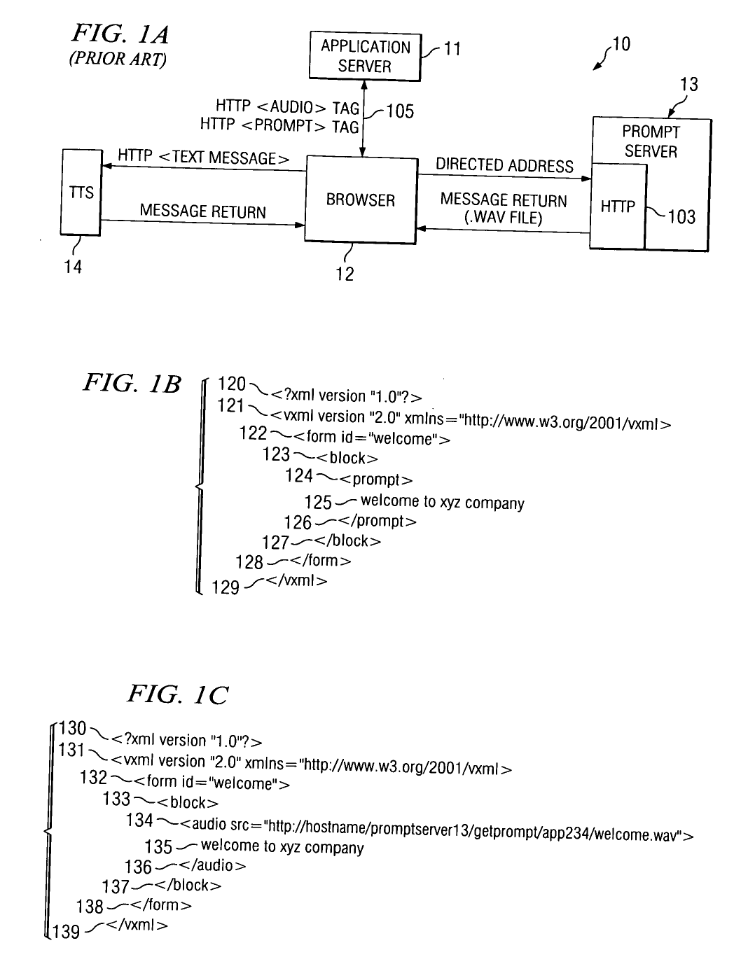

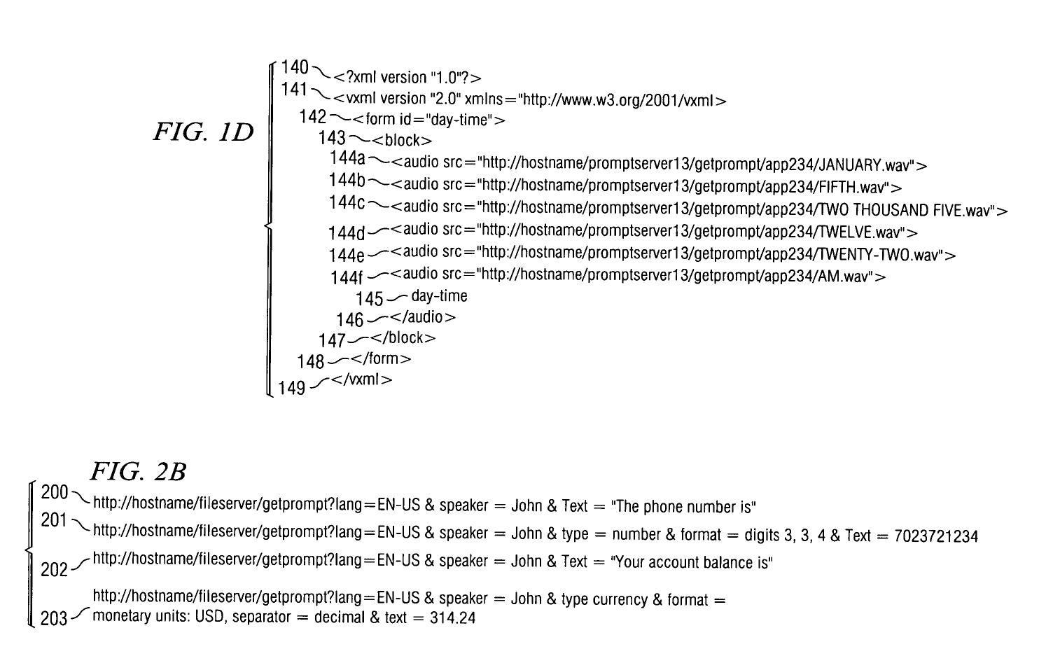

FIG. 1A shows a typical prior art system 10 having application server 11 interfacing with browser 12. Browser 12 can be configured with HTTP protocol and can interface with audio file server 13 via HTTP interface 103. When a VXML script is executed in the browser 12 containing the <audio> tag the browser will request the file from the enhanced file server using key-value pairs. Similarly the VXML script can request audio files from the TTS engine 14 using the <prompt> tag as discussed above using the MRCP protocol.

Using the VXML scripting language (in this case version 2.0) the first step is to define the desired conversational script as a Voice XML document using the <VXML> tag. FIG. 1B, lines 120, 121, 122, show the beginning stages of the dialog which is the basic structure of a VXML scripting interface. There are two dialog states; namely, <form> and <menu>. In the example, we will use the <form> state.

Lines 123 and 124 of FIG. 1B begins a form item, in this case a <block> item which illustrates the <prompt> tag. As discussed above, the <prompt> tag will send the message to a text-to-speech (TTS) engine, such as TTS engine 14. Line 125 then contains the message that is to be rendered by TTS engine 14 (FIG. 1A). Lines 126-129 end the conversation with browser 12.

FIG. 1C illustrates the use of the <audio> tag. In this situation, lines 130-133 are the same as lines 120-123 of FIG. 1B. Line 134 specifies the <audio> tag and specifies the exact address (such as: http://hostname/AudioFileServer13/getaudiofile/app234/welcome.wav) of the desired file. This is a fully resolved address and thus browser 12 sends a message to audio file server 13 to retrieve file located in file folder app234 with the file being known as “welcome.wav” which file contains the message “welcome to XYZ company.” Note that line 135 defines the expected utterance that is expected to be contained in file welcome.wav in folder app234. However, if the content of the file in folder app234 had been changed, then line 135 would be wrong. Lines 136-139 are the same as lines 126-129 of FIG. 1B and end the conversation.

The method just discussed assumes that the full path route to the desired file is known. This is a fully resolved address location. However, as discussed above there is a series of situations where variable fields must be rendered. Using the prior art system as shown in FIG. 1A the variable field, such as your account balance is $314.24, would have to be in a <prompt> message delivered to text-to-speech engine 14 so that the proper response could be generated.

FIG. 1D illustrates the use of multiple <audio> tags that present multiple URLs, each describing a single piece of the final field (i.e. “day-time”) to eventually build the full field utterance. In this situation, lines 140-143 are the same as lines 120-123 of FIG. 1B. Line 144a-144f each specifies the <audio> tag for a piece of the utterance and specifies the exact address (such as: http://hostname/AudiofileServer13/getaudiofile/app234/January.wav) of the desired file. This is a fully resolved address and thus browser 12 sends a message to audio file server 13 to retrieve file located at file location 234 with the file being known as “January.wav” which file contains the message stating the utterance “January.” Note that line 145 is the full message that is expected in file folder app234. However, if the content of the file in location 234 had been changed, then line 145 would be wrong. Lines 146-149 are the same as lines 126-129 of FIG. 1B and end the conversation. In this prior art case, each play command has to be individually sent from the browser to the audio server, and each individual audio clip has to be sent back to the browsers, who splices all of the clips together.

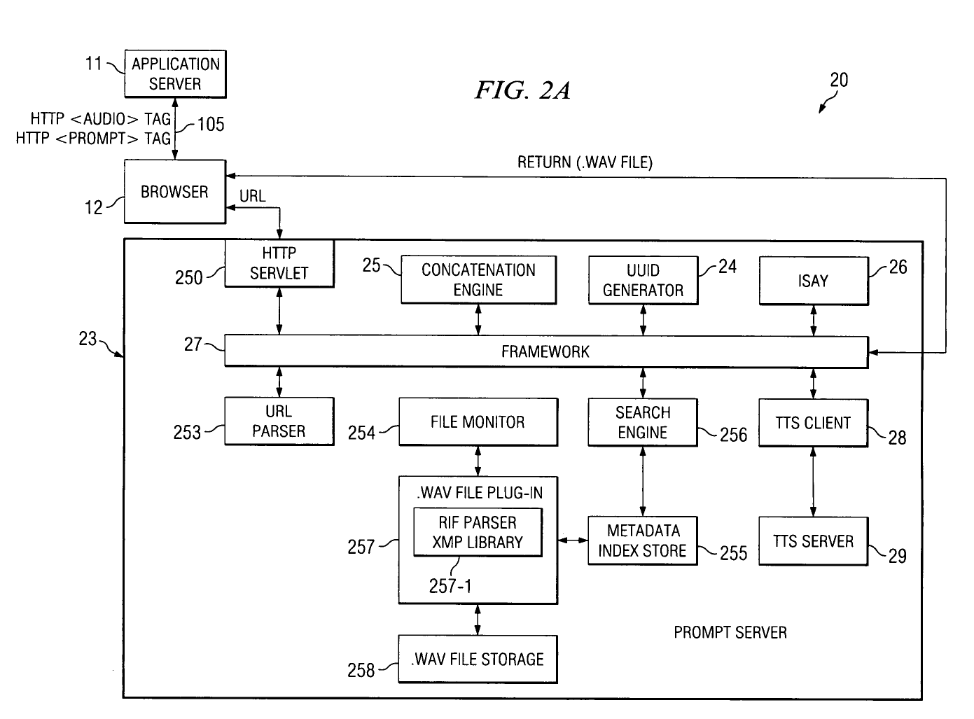

FIG. 2A shows one embodiment of system 20 for efficiently splicing audio clips together to create variable field utterances (dates, times, monetary amounts, etc.) by specifying the attributes of the variable field (type, text, speaker, language, etc.). The audio file server 23 will retrieve messages from .wav file storage 258 according to the attributes in the variable-field file request. In this embodiment, audio file server 23 contains TTS client 28 and TTS server 29 to render audio files when such audio files have not been prerecorded or can not, for one reason or another, be retrieved from the .wav file storage.

Advantage is taken of the HTTP protocol which allows data contained in a communication line to be passed to a target destination if that data falls after the query marker “?” in the communication line. This is known as a query URL and in the context of this disclosure it is also known as a decorated URL. The W3C standard for URLs allows a question mark followed by any data intended for the final recipient of the request. Data following the “?” is defined as a “query”, which will be ignored by intermediate entities handling the request. The query data is intended to be handled and acted upon by the final server targeted in the URL. Thus, by establishing audio file server 23 as the target, an application from, for example, application server 11, creates a document using the VXML scripting protocol, and communicates the document with browser 12, using, for example, the standard HTTP protocol.

Within the VXML document, there is a VXML audio tag, with a query URL describing the audio file along with various attributes of the required audio file, including the audio file's text, speaker, and language. The audio tag causes an HTTP request to be sent to the audio file server. The HTTP request does not have a fully-resolved address pointing to the specific audio file to be played. Instead, the HTTP request contains a query attribute string, which the audio file server will use to determine the appropriate set of pre-recorded audio files (.wav file) that need to be spliced together to return the correct utterance to the voice browser. Audio file server 23 must decode (or resolve for itself) how to build the complete audio file that it will return to the browser.

In such a situation it is possible to specify many attributes about the required audio file. Some of the most significant audio file attributes to be specified would be the text of the utterance to be spoken, and the language it is to be spoken in. Other attributes, such as the speaker, whether the message should be male or female, the age of the recorder (child, adult, etc.), the emotional feel of the utterance, etc., can also be specified, but can be optional. The audio file server then determines which set of files to splice together based on the attributes of the message.

FIG. 2B shows an example of two URL commands 201 and 203 issued by the browser and delivered to the file server. These URLs will cause the enhanced file server to splice together all of the appropriate audio clips to produce two different variable-field utterances. The URL 201 is sent to the file server 20 from the browser after the browser has parsed the second <audio> tag. The file server's URL parser 253 looks at the URL's attributes and determines that this URL requires a set of spliced files to be merged into a single file instead of retrieving a single audio file. Then the attributes parsed by the URL parser are passed to the ISAY module 26. The ISAY module determines the exact set of audio clips required to make up the full variable-field utterance, including references to the correctly-inflected audio clips and the sequence the clips must be spliced. Then the ordered list of clips is passed to the concatenation engine 25 to be spliced together. The concatenation engine retrieves the actual audio clips from the .wav file storage 258 and splices the audio clips together in the order dictated by the ISAY module. After the clips have been spliced together the completed single audio file (.wav file) is then set to the browser as a single utterance that speaks the complete variable-field value, e.s. $314.24.

URLs 200 and 201 would be used to cause the browser to say “The phone number is 702-372-1234.” The final utterance of the phone number will be phrased with two groups of three digits (area code and exchange) and one groups of four digits, to be more natural sounding. In addition the individual digits can be individually inflected up, down, or neutral, depending on that digit's position in the string, to make it even more natural-sounding. All of the phrasing and inflecting are handled automatically in the enhanced file server. URL 201 cause a single file to be returned to the browser. While the browser is playing the file, URL 201 may be sent to the file server.

URL 201 causes the enhanced file server 23 to splice together all of the digits of a 10-digit phone number, and phrase the number in three digit groups with slight pauses in between the groups, and different inflections for different numeric positions within each group. The “attribute format=3, 3, 4” sets the phrasing of the digits 702-372-1234.

As another example, URLs 202 and 203 may be used to inform a caller that “Your account balance is $314.24.” Initially, the user asks to hear their account balance. The application queries a database to get the balance amount and builds a VSML script document with the <audio> tags and its associated URL. Like the phone number, the monetary amount will be phrased naturally, and the digits will be individually inflected.

The first audio tag would request a single audio file from the file server saying “Your account balance is?” using URL 202. The <audio> tag would place the metadata describing the audio file it required in the URL associated with the audio tag using the previously described metadata techniques described in U.S. patent application Ser. No. ______ [Attorney Docket No. 47524-P137US-10501428] entitled “SYSTEM AND METHOD FOR MANAGING FILES ON A FILE SERVER USING EMBEDDED METADATA AND A SEARCH ENGINE,” and U.S. patent application Ser. No. ______ [Attorney Docket No. 47524-P138US-10501429] entitled “SYSTEM AND METHOD FOR RETRIEVING FILES FROM A FILE SERVER USING FILE ATTRIBUTES,” which are incorporated herein by reference. The second part of the VXML script would request the utterance speaking the monetary amount. This would be scripted in VSML with a second <audio> tag, where the associated URL would contain all of the attributes to describe the text, type, speaker, language, etc. of the monetary amount variable field.

Within the variable-field URL request (FIG. 2B), the field text and field type attributes define the basic parameters of what is to be said. The language and speaker parameters define who is to say it, and in what language. Other attributes can define emotions, dialects etc. for the utterance.

Note that audio file server 23 upon receiving the URL request uses search engine 256 (FIG. 2A) or any other mechanism to find the messages that are required to create the specified variable-field message. If any of the messages required to make the variable field message file are not available, the process fails. The request could optionally be passed to TTS server 29 via TTS client 28 to be rendered from scratch.

While the browser is playing the utterance “Your account balance is,” URL 203 is requested, making the enhanced file server splice together the audio clips to say “$314.24” which is sent to the browser as a single file to be played as soon as the first message has completed.

Line 203 is an illustration of a variable format where it is a currency format and U.S. English with monetary units using the U.S. dollar and the separator being a decimal where the text is 31424. This message is rendered as $314.24.

Note that as we have been discussing, the information beyond the“?” marker is passed to audio file server 23 for operation by search engines and/or software working under audio file server 23. Line 203 could have been modified to specify that the currency is “German”, the separator is a “coma” and the monetary units, for example, could be “CHF”. Also note that it is possible to render the voice in one language and the monetary value in a different language such that you could have a U.S. speaker delivering a monetary amount which is in, for example, Euros. This is accomplished by changing the statement within line 203. This same type of operation can be used for any variable field, for example, month, day and year by specifying in the audio file line what it is that is desired as a type. Thus, by combining lines, the audio file server will return messages in sequence such that the user would hear that the user perceives to be a unified message such as “Your account balance is $314.24.” All of this “unified” message would have been generated without the use of a TTS engine even though the variable fields had not been identified and prerecorded as a continuous message.

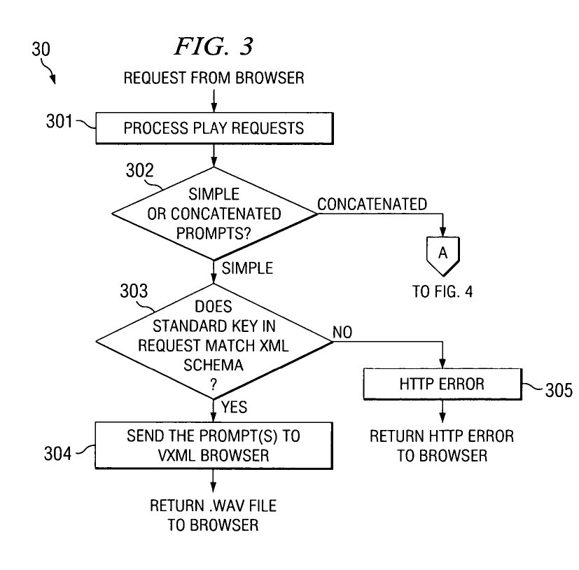

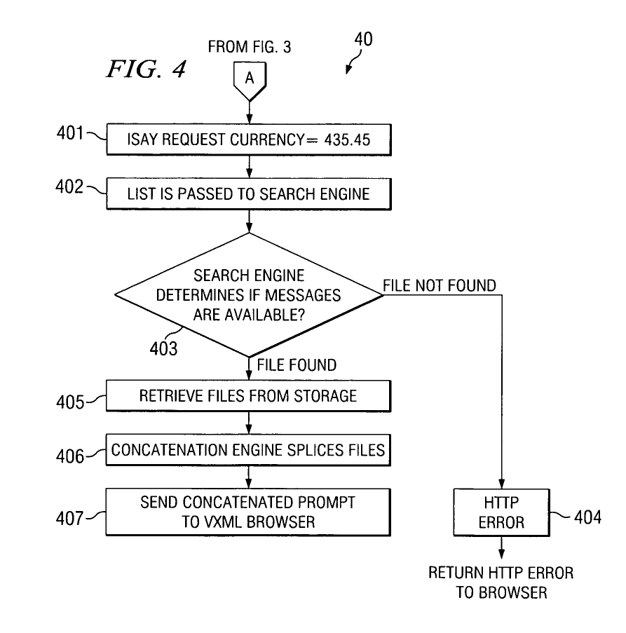

FIG. 3 shows one embodiment 30 of a process for delivering a audio file in response to receipt of a query URL containing metadata. In box 401, a request from a browser is received by HTTP servlet 250 (FIG. 2A) which passes through framework 27 to URL parser 253. After the URL is parsed, the process determines whether the request is a simple file request or a request for a concatenated set of files, 302. A URL request requesting a variable-field multiple-clip utterance will be discovered at the URL parser stage, before the attributes are examined. The presence of a “field type” attribute in the URL tells the parser 253 that this request is for a prompt to be built from multiple spliced audio clips instead of a single file request. If there is no “field type: attribute, then the process assumes that the request is a request for a single file and proceeds to block 403.

If the request is for a single file, the parsed request with its extracted metadata attributes is then passed to search engine 256 which looks up the requested attributes for the specific single audio file in metadata index store 255. When all of the attribute values have been found in the index, the search engine validates the metadata attributes with the RIFF parser XMP library 257-1 then, as shown by process 303. The validation process determines if the standard keys and values in the parsed request matches a proper XML schema. For example, if language=Spanish, process 303 would show a “yes.” However, if language=male, the process 303 would return a “no.” If a “no” is returned, process 305 reports an HTTP error. If all of the attribute/value pairs are correctly validated, the search engine retrieves the audio file from the .wav file storage and send it to the requestor (browser in this case), block 304.

If, however, process 302 determines that the query is a concatenated set of files then a process, such as process 40 illustrated in FIG. 4, is used to handle the concatenation.

FIG. 4 illustrates a specific example of the more general situation where strings of data must be put together to form a proper audio file response.

In block 401, the URL parser 253 passes the list of attributes to the ISAY module 25, where the attributes are examined to determine what kinds of files will be required to create the final audio file. The ISAY module will need to know the field type, the text, and the requested language, to know just what types of messages to put together to make the final utterance. However, the ISAY module does not look at the requested speaker or emotions, etc. These attributes will be carried on for other system elements to deal with.

Once the types of messages and their order are defined by ISAY, the list is passed to the search engine module. The list from ISAY will include the numbers, months, etc., but the speaker, block 402, and emotion attributes will be passed to the search engine separately. It will be the job of the search engine to see if audio clip utterance of the number “two” requested by the ISAY module is available spoken by the speaker and in the emotion requested in the original variable-field request.

The search engine looks in the metadata index store to see if the set of messages “four” “hundred” “thirty” “five” “dollars” “and” “forty” “five” “cents” are all available in the index, block 403. If not, the process issues an error, block 404.

If all of the required audio clips are available, the search engine uses the index pointers to the files to retrieve the files from the .wav file storage and return the files to the concatenation engine, block 405.

The concatenation engine splices all of the retrieved files together in the order specified in the ISAY module's list and sends the completed singular .wav file to the HTTP servlet, block 406.

The HTTP servlet sends the final .wav file back to the browser, where the file is played to the user “Your account balance is $435.45” It is assumed that a previous single-file prompt “Your account balance is” was played just before the variable-fields prompt, to clarify the meaning of the variable-field monetary amount prompt.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. An audio file server comprising:
a plurality of audio files;
means for receiving requests for selected ones of said audio files said request comprising a text version of a desired audio file together with attributes of said audio file; and
means for retrieving a requested audio file by parsing said attributes associated with said request.

2. The audio file server of claim 1 wherein said receiving means comprises a communication line using HTTP VXML standard protocol.

3. The audio file server of claim 2 wherein said receiving means further comprises:
using the “?” marker in the HTTP protocol to send said request for an audio file together with said attributes.

4. The audio file server of claim 1 wherein said receiving means comprises providing said request and said attributes to said audio file server as a decorated URL.

5. The audio file server of claim 1 wherein said retrieving means comprises:
means for identifying the universe of audio files matching said text message; and
means for eliminating from said selection any of said identified audio files that do not have all of said attributes associated therewith.

6. A voice audio file server comprising:
a system for selecting a voice file from among a plurality of voice files, said system operative to parse attributes of said voice file associated with requests received for said voice file.

7. The voice audio file server of claim 6 wherein said requests include text versions of said requested voice file together with attributes which further uniquely identify one voice file from a plurality of voice files matching said text version.

8. The voice audio file server of claim 7 wherein said voice file is retrieved in .wav format.

9. The voice audio file server of claim 6 wherein said requests arrive at said audio file server as a decorated URL from a browser.

10. A web based IVR system comprising:
an application server for providing control for various applications that are available to users;
a voice browser interposed between said application server and said users, said voice browser operable for interfacing audio commands to/from said user and said application server and wherein certain of said commands from said application server contain requests identifying audio messages to be delivered to said user; and
an audio file server for receiving requests for audio files under control of said voice browser, said audio file server operable for retrieving a requested existing audio file for delivery to said user, wherein said retrieved audio file is identified by attributes associated with said requested file.

11. The system of claim 1 wherein said requests come to said voice browser on a HTTP protocol communication line using the VXML protocol.

12. The system of claim 11 wherein said request is included in said HTTP communication line as a decoration to said communication line.

13. The system of claim 12 wherein said decoration comes after a marker in said communication lines.

14. The system of claim 10 wherein said audio file is determined based on said text segment.

15. The system set forth in claim 10 further comprising:
a text-to-speech converter for rendering text segments into audio when said audio file server is unable to retrieve a requested file.

16. The system of claim 10 wherein at least some of said audio files have been stored by a system user.

17. The system of claim 1 further comprising:
means for controlling the rate an audio file is played to a user.

18. The system of claim 1 wherein said audio file server further comprises:
an indexing engine for matching attributes associated with said request with attributes stored in association with said messages.

19. A method for retrieving audio files from an audio file server, said method comprising:
sending a decorated URL to a browser, said decorated URL addressing said audio file server, but leaving the specifically desired audio file unresolved; and
resolving the storage location of said specifically desired audio file by said audio file server.

20. The method of claim 19 wherein said resolving further comprises:
receiving a text version of said desired audio file together with attributes for further defining said desired audio file from among the universe of audio files that otherwise would match said text version.

21. The method of claim 20 wherein said text version and said attributes comprise the decorated portion of said URL.

22. A method for retrieving audio files from a audio file server, said method comprising:
creating a audio file request in the HTTP protocol, said audio file request addressing said audio file server and containing data pertaining to a desired audio file, but not address of location of said desired audio file; and
a browser for receiving said audio file request and for directing said data within said audio file request to a audio file server in accordance with said audio file-server-request.

23. The method of claim 22 further comprising:
resolving within said audio file server, the address location of said desired audio file based upon said directed data.

24. The method of claim 22 wherein said data contains a message statement and attributes of said message statement for uniquely identifying said desired audio file from among a plurality of possible statements that would otherwise match said provider message statement.

25. A web based IVR system comprising:
an application server for providing control for various applications that are available to users;
a voice browser interposed between said application server and said users, said voice browser operable for interfacing voice commands to/from said user and said application server and wherein certain of said commands from said application server contain text segments requiring rendering into speech segments for delivery to said user; and
an audio file server for receiving said text segments under control of said voice browser, said audio file server operable for rendering said text segments into corresponding .wav segments for delivery to said user, wherein at least some of said text segments are not identified by a specific address.

26. The system of claim 25 wherein said voice browser and said audio file server communicate using an HTTP protocol.

27. The system of claim 26 wherein said text segments are included in said HTTP protocol at a point in said protocol after a marker.

28. The system of claim 27 wherein said marker is a “?”.

29. The system of claim 26 wherein said specific address is a URL address.

30. The system of claim 26 wherein at least some of said test segment comprise prerecorded words that are to be concatenated in accordance with instructions provided in said protocol.

31. The system of claim 25 further comprising:
means in association with said audio file server for reading metadata contained in at least one of said test segments, and
means for retrieving stored .wav files based on read ones of said metadata.
